(19) United States
(12) Patent Application Publication
(10) Pub. No.: US 2026/0012526 A1
(43) Pub. Date: Jan. 8, 2026

(54) VEHICLE-MOUNTED AND HOUSEHOLD DUAL-PURPOSE MAGNETIC, ROTATABLE AND FOLDABLE MOBILE PHONE HOLDER CAPABLE OF BEING FREELY ADSORBED

(71) Applicant: Dongguan Jinchi Electronic Technology Co., Ltd., Dongguan (CN)

(72) Inventor: Pengcheng DU, Dongguan (CN)

(21) Appl. No.: 19/187,354

(22) Filed: Apr. 23, 2025

(30) Foreign Application Priority Data
Jul. 3, 2024 (CN) 202421551172.3

(51) Int. Cl. H04M 1/04; F16M 11/04; F16M 11/12; F16M 13/02

(52) U.S. Cl. CPC H04M 1/04; F16M 11/041; F16M 11/125; F16M 13/022

(57) ABSTRACT

The present disclosure relates to a vehicle-mounted and household dual-purpose magnetic, rotatable and foldable mobile phone holder capable of being freely adsorbed. The mobile phone holder includes a ring body, a housing and a bottom housing. A connection position is arranged in a bottom of the housing, a silica gel sucker is arranged at a bottom of the bottom housing, and the bottom housing and the silica gel sucker are connected to the connection position through pins. The ring body is provided with a magnet, the magnet is provided with a panel, and the ring body is connected to a swing rod. Two ends of the swing rod are connected to a first connecting block or a second connecting block through a rotating shaft, the first connecting block is connected to the ring body through a screw, and the second connecting block is connected to the housing through screws.

### CROSS-REFERENCE TO RELATED APPLICATIONS

The present application claims priority to Chinese Patent Application No. 202421551172.3, filed on Jul. 3, 2024, the entire disclosure of which is incorporated herein by reference.

### TECHNICAL FIELD

The present disclosure relates to the technical field of vehicle-mounted furniture, and in particular to a vehicle-mounted and household dual-purpose magnetic, rotatable and foldable mobile phone holder capable of being freely adsorbed.

### BACKGROUND

At present, magsafe magnetic holders in a use environment of vehicle-mounted holders capable of being stuck on the market are inconvenient for angle adjustment and incompatible with POPsockets (airbag ring holder) and Ring (ordinary ring holder). Generally, holders capable of being stuck are only stuck on one type of products, which is inapplicable to products that require different use scenarios.

A vehicle-mounted holder is usually fixed on a plane console of a vehicle with glue. When a use position needs to be changed, dismounting is inconvenient due to glue, and it is difficult to clean glue residue.

Therefore, a vehicle-mounted and household dual-purpose magnetic, rotatable and foldable mobile phone holder capable of being stuck is invented.

### SUMMARY

An objective of the present disclosure is to provide a vehicle-mounted and household dual-purpose magnetic, rotatable and foldable mobile phone holder capable of being freely adsorbed, so as to solve the problems mentioned in the background art.

To achieve the above objective, the present disclosure provides the technical solutions as follows:

A vehicle-mounted and household dual-purpose magnetic, rotatable and foldable mobile phone holder capable of being freely adsorbed, including a ring body, a housing and a bottom housing, where a connection position is arranged in a center of a bottom of the housing, a silica gel sucker is arranged at a bottom of the bottom housing, and the bottom housing and the silica gel sucker are connected to the connection position through pins.

The ring body is fixedly provided with a magnet, the magnet is provided with a panel, and the ring body is connected to a swing rod.

Two ends of the swing rod are connected to a first connecting block or a second connecting block through a rotating shaft, the first connecting block is connected to the ring body through a screw, and the second connecting block is connected to the housing through screws.

An end, farthest away from the bottom housing, of the silica gel sucker is fixedly provided with suction cups, and a decorative plate is arranged in a middle of the silica gel sucker.

In a preferred embodiment of the present disclosure, insertion holes are formed at a circumference of the connection position, and a ball plunger is mounted inside each insertion hole.

In a preferred embodiment of the present disclosure, each ball plunger is composed of a ball retainer housing, a spring and a ball, the ball retainer housing is fixedly mounted in the insertion hole, the spring is mounted inside the ball retainer housing, the spring is compressed and connected to the ball, and the ball is clamped on the ball retainer housing.

An inner wall of the bottom housing is circumferentially provided with positioning grooves, and the balls extend out of the ball retainer housings and are connected to the positioning grooves.

In a preferred embodiment of the present disclosure, a cable clip is fixedly mounted at a top of the housing.

Additional aspects and advantages of the present disclosure will be set forth partially in the following description, which will become obvious in the following description, or may be learned by practice of the present disclosure.

The ring body is fixedly provided with the magnet, the magnet is provided with the panel, and the ring body is connected to the swing rod. The ring body at an upper portion can be compatible with POPsockets (airbag ring holder) and Ring (ordinary ring holder). The hollow design of the ring body is compatible with POPsockets (airbag ring holder) and Ring (ordinary ring holder) for use and is applicable to bare mobile phones of magsafe Iphone mobile phones and magsafe magnetic housings, and the mobile phone holder can be used in combination with ring iron sheets for mobile phones of other models.

The housing and the bottom housing are tightly connected through the connection position and the pins, such that rotation of the mobile phone holder is realized. The balls are designed inside the housing and are in a compressed state. The balls are connected into the positioning grooves to realize the effect of keeping an angle unchanged after rotation, that is, the bottom housing can realize a high-angle rotation and hovering function.

The end, farthest away from the bottom housing, of the silica gel sucker is fixedly provided with the suction cups, and the suction cups on the silica gel sucker can be directly adsorbed on a plane workbench of a vehicle.

### BRIEF DESCRIPTION OF THE DRAWINGS

The above-mentioned and/or additional aspects and advantages of the present disclosure will become apparent and easy to understand from the description of the examples with reference to the following accompanying drawings, in which:

FIG. 1 is a schematic exploded diagram of a vehicle-mounted and household dual-purpose magnetic, rotatable and foldable mobile phone holder capable of being freely adsorbed.

FIG. 2 is a first perspective diagram of a vehicle-mounted and household dual-purpose magnetic, rotatable and foldable mobile phone holder capable of being freely adsorbed.

FIG. 3 is a second perspective diagram of a vehicle-mounted and household dual-purpose magnetic, rotatable and foldable mobile phone holder capable of being freely adsorbed.

FIG. 4 is sectional view of a vehicle-mounted and household dual-purpose magnetic, rotatable and foldable mobile phone holder capable of being freely adsorbed.

FIG. 5 is a schematic structural diagram of a bottom housing in a vehicle-mounted and household dual-purpose magnetic, rotatable and foldable mobile phone holder capable of being freely adsorbed.

FIG. 6 is a schematic structural diagram of a ball plunger in a vehicle-mounted and household dual-purpose magnetic, rotatable and foldable mobile phone holder capable of being freely adsorbed.

FIG. 7 is a perspective diagram of a silica gel sucker in a vehicle-mounted and household dual-purpose magnetic, rotatable and foldable mobile phone holder capable of being freely adsorbed.

In the figures: 100. ring body; 110. magnet; 120. panel. 130. screw; 200. swing rod; 210. first connecting block; 220. second connecting block; 230. rotating shaft; 300. housing; 320. insertion hole; 330. connection position; 400. ball plunger; 410. ball retainer housing; 420. spring; 430. ball; 500. bottom housing; 510. silica gel sucker; 511. positioning groove; 520. suction cup; 530. pin; 540. decorative plate; and 600. cable clip.

### DETAILED DESCRIPTIONS OF THE EMBODIMENTS

Examples of the present disclosure are described in detail below, instances of the examples are shown in the accompanying drawings, throughout which identical or similar reference numerals denote identical or similar elements or elements having identical or similar functions. The examples described below with reference to the accompanying drawings are exemplary and intended to explain the present disclosure, instead of being construed as limiting the present disclosure.

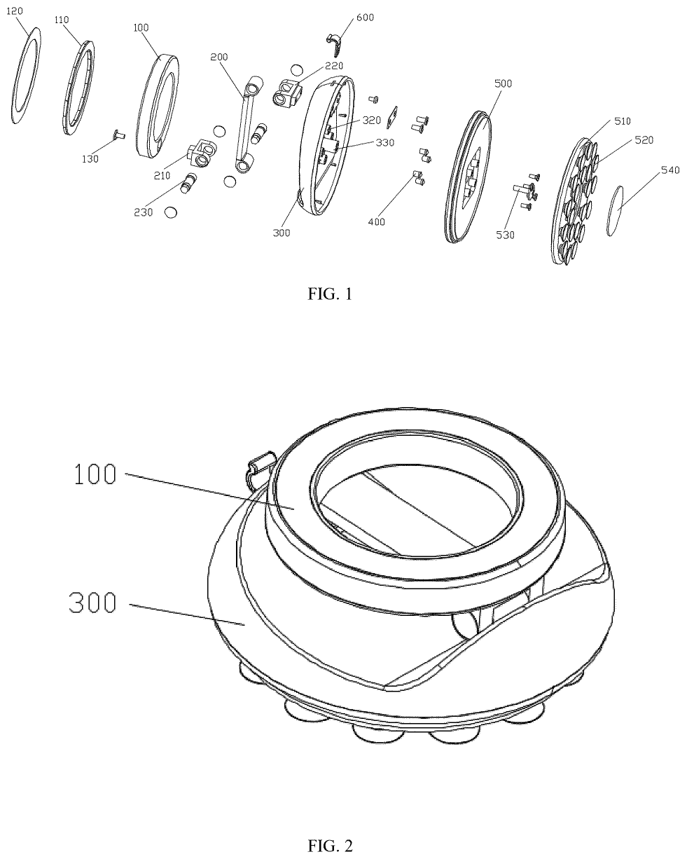

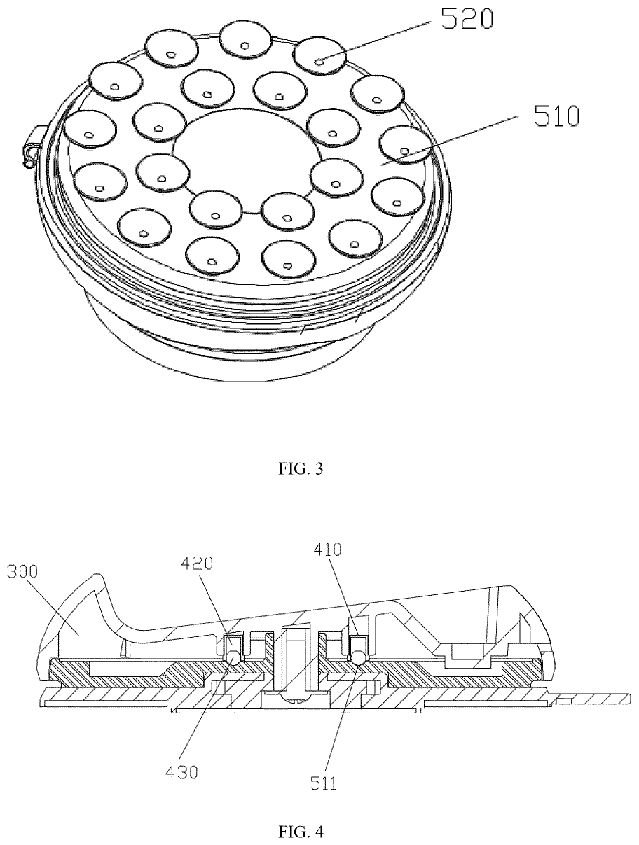

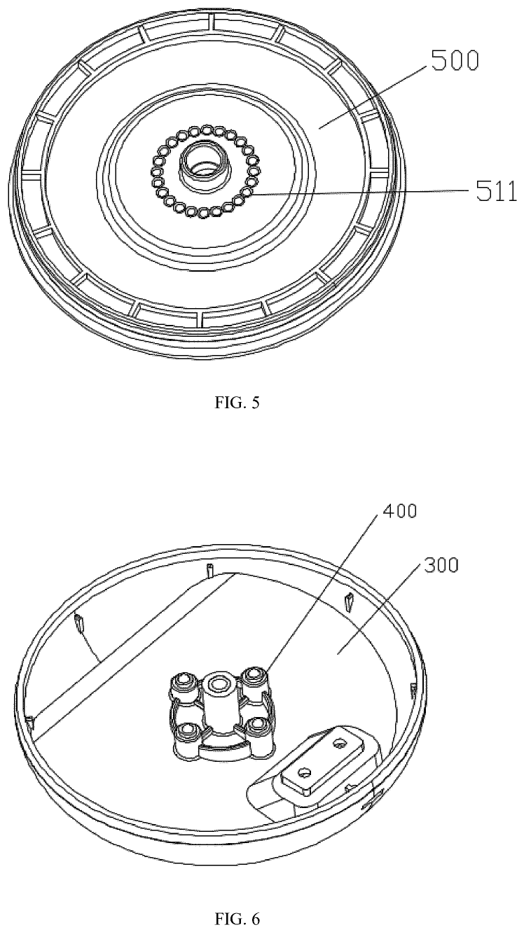

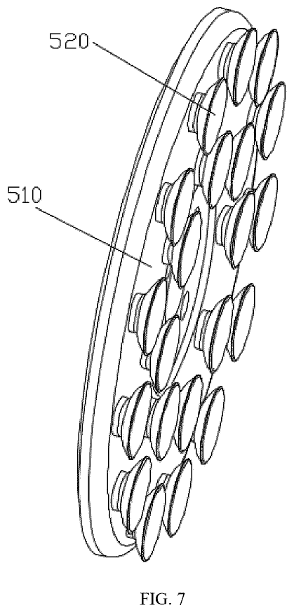

Referring to FIGS. 1-7, a vehicle-mounted and household dual-purpose magnetic, rotatable and foldable mobile phone holder capable of being freely adsorbed, including a ring body 100, a housing 300 and a bottom housing 500, where a connection position 330 is arranged in a center of a bottom of the housing 300, a silica gel sucker 510 is arranged at a bottom of the bottom housing 500, and the bottom housing 500 and the silica gel sucker 510 are connected to the connection position 330 through pins 530.

The ring body 100 is fixedly provided with a magnet 110, the magnet 110 is provided with a panel 120, and the ring body 100 is connected to a swing rod 200. The swing rod 200 can realize an up-and-down folding function, and the ring body 100 at an upper portion can be compatible with POPsockets (airbag ring holder) and Ring (ordinary ring holder). The hollow design of the ring body 100 is compatible with POPsockets (airbag ring holder) and Ring (ordinary ring holder) for use and is applicable to bare mobile phones of magsafe Iphone mobile phones and magsafe magnetic housings, and the mobile phone holder can be used in combination with ring iron sheets for mobile phones of other models.

Two ends of the swing rod 200 are connected to a first connecting block 210 or a second connecting block 220 through a rotating shaft 230, the first connecting block 210 is connected to the ring body 100 through a screw 130, and the second connecting block 220 is connected to the housing 300 through screws. The rotating shaft 230 is arranged as a damping rotating shaft and has a 360-degree rotation and hovering function, such that the swing rod can swing, and a component at the upper portion can hover.

Insertion holes 320 are formed at a circumference of the connection position 330, and a ball plunger 400 is mounted inside each insertion hole 320. Each ball plunger 400 includes a ball retainer housing 410, a spring 420 and a ball 430, the ball retainer housing 410 is fixedly mounted in the insertion hole 320, the spring 420 is mounted inside the ball retainer housing 410, the spring 420 is compressed and connected to the ball 430, and the ball 430 is clamped on the ball retainer housing 410.

An inner wall of the bottom housing 500 is circumferentially provided with positioning grooves 511, and the balls 430 extend out of the ball retainer housings 410 and are connected to the positioning grooves 511, thereby realizing a rotation function of the mobile phone holder. The housing 300 and the bottom housing 500 are tightly connected through the connection position 330 and the pins 530, such that rotation of the mobile phone holder is realized. The balls 430 are designed inside the housing 300 and are in a compressed state. The balls 430 are connected into the positioning grooves 511 to realize the effect of keeping an angle unchanged after rotation, that is, the bottom housing 500 can realize a 360-degree rotation and hovering function.

A cable clip 600 is fixedly mounted at a top of the housing 300.

An end, farthest away from the bottom housing 500, of the silica gel sucker 510 is fixedly provided with suction cups 520, and a decorative plate 540 is arranged in a middle of the silica gel sucker 510.

The suction cups 520 on the silica gel sucker 510 can be directly adsorbed on a plane workbench of a vehicle.

The working principle of the present disclosure is: POPsockets (airbag ring holder), Ring (ordinary ring holder) or a mobile phone housing with metal are adsorbed on the ring body 100, and the swing rod 200 can realize the up-and-down folding function. The balls 430 are connected into the positioning grooves 511 by rotating the housing 300 or the bottom housing 500, that is, the bottom housing 500 can realize the 360-degree rotation and hovering function. A cable of the mobile phone can be fixed on the cable clip 600. The end, farthest away from the bottom housing 500, of the silica gel sucker 510 is fixedly provided with the suction cups 520, and the suction cups 520 on the silica gel sucker 510 can be directly adsorbed on the plane workbench of the vehicle.

Although the examples of the present disclosure have been illustrated and described, it should be understood that those of ordinary skill in the art may make various changes, modifications, replacements and variations to these examples without departing from the principle and purpose of the present disclosure, and the scope of the present disclosure is limited by the appended claims and their legal equivalents.

What is claimed is:

1. A vehicle-mounted and household dual-purpose magnetic, rotatable and foldable mobile phone holder capable of being freely adsorbed, comprising a ring body, a housing and a bottom housing, wherein a connection position is arranged in a center of a bottom of the housing, a silica gel sucker is arranged at a bottom of the bottom housing, and the bottom housing and the silica gel sucker are connected to the connection position through pins;
the ring body is fixedly provided with a magnet, the magnet is provided with a panel, and the ring body is connected to a swing rod;
two ends of the swing rod are connected to a first connecting block or a second connecting block through a rotating shaft, the first connecting block is connected to the ring body through a screw, and the second connecting block is connected to the housing through screws; and
an end, farthest away from the bottom housing, of the silica gel sucker is fixedly provided with suction cups, and a decorative plate is arranged in a middle of the silica gel sucker.

2. The vehicle-mounted and household dual-purpose magnetic, rotatable and foldable mobile phone holder capable of being freely adsorbed according to claim 1, wherein insertion holes are formed at a circumference of the connection position, and a ball plunger is mounted inside each insertion hole.

3. The vehicle-mounted and household dual-purpose magnetic, rotatable and foldable mobile phone holder capable of being freely adsorbed according to claim 2, wherein each ball plunger comprises a ball retainer housing, a spring and a ball, the ball retainer housing is fixedly mounted in the insertion hole, the spring is mounted inside the ball retainer housing, the spring is compressed and connected to the ball, and the ball is clamped on the ball retainer housing; and
an inner wall of the bottom housing is circumferentially provided with positioning grooves, and the balls extend out of the ball retainer housings and are connected to the positioning grooves.

4. The vehicle-mounted and household dual-purpose magnetic, rotatable and foldable mobile phone holder capable of being freely adsorbed according to claim 1, wherein a cable clip is fixedly mounted at a top of the housing.
